(19) United States
(12) Patent Application Publication
(10) Pub. No.: US 2002/0199020 A1
(43) Pub. Date: Dec. 26, 2002

(54) Method and system for resolving names on a network gateway having multiple distinct network interfaces

(75) Inventors: Rob M. Trace, Redmond, WA (US); Mohammad Shabbir Alam, Bellevue, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA (US)

(21) Appl. No.: 09/888,707

(22) Filed: Jun. 25, 2001

(51) Int. Cl. G06F 15/16

(52) U.S. Cl. 709/245; 709/203

(57) ABSTRACT

A new method and naming proxy are disclosed for resolving resource names over multiple subnets interconnected via a machine having multiple network interfaces. The discloses system comprises a network naming proxy server embedded within the multi-interface machine. The naming proxy executes resource discovery requests over the multiple interfaces. The machine executes a RAS server that supports connections to a RAS client on a first interface and a local area network on a second interface. The naming proxy receives requests on the first interface and forwards naming queries corresponding to the received requests via the second interface. The naming proxy includes a resource name-to-address cache for temporarily storing the addresses that it receives for resources connected via the multiple network interfaces.

### AREA OF THE INVENTION

The present invention generally relates to the area of network operating systems, and to gateways providing access by remotely connected client computers to network resources. More particularly, the present invention is directed to network services for registering and resolving submitted names to render a network address.

### BACKGROUND OF THE INVENTION

A primary service provided by a known network name registration and resolution (“naming”) proxy (i.e., MICROSOFT's NetBT-WINS proxy) is facilitating name registration and resolution for other computers that are unable to resolve names (e.g., non-WINS enabled computers—usually configured as Broadcast-nodes and otherwise commonly known as “B-nodes”). The known network name registration and resolution proxy listens for name registrations on a particular network interface and then provides addresses for computers that are unable to resolve a particular name on their own. Such requests (i.e., name registration and resolution) are examples of name service requests. Name service requests generally involve providing information relating to mapping names to addresses or possibly other linked information. The known proxy was intended to reduce the load on the WINS server by caching names on behalf of the WINS server and serving local client computers based upon the cached name information.

The known proxy performs name registration/resolution in a manner as summarized herein below. The proxy, through a network interface listens on a local subnet for broadcast name registrations and queries. For example, the proxy listens for NetBIOS computer names and their corresponding Internet Protocol (IP) addresses. When a computer (e.g., a B-node) sends a name-related broadcast, the proxy accepts the broadcast and checks its name registration/resolution cache for the appropriate NetBIOS computer name-to-IP-address mapping.

The proxy provides any of a number of different responses to a broadcast based upon the request type and the contents of the proxy's naming cache. If the proxy has the appropriate mapping in its cache, then in the case of a name registration the proxy sends a negative name registration response if the IP address in the cache for the broadcast name differs from the broadcast address. In the case of a name query, the proxy transmits a positive name query response including a network address to the B-node machine. If the name-to-IP-address mapping did not exist, within the proxy's cache, for the broadcast name, then the proxy queries a network naming (e.g., WINS) server for that name on behalf of the B-node machine and caches the returned address for the name. The proxy sends the cached address as a response when the proxy receives the next broadcast from a requesting B-node machine for the name.

Once the proxy resolves a name, it keeps it in its cache for a limited period of time. A typical period is ten minutes. Thereafter, the name and associated network address are invalidated. The known NetBT proxy also sends a negative response when the name sought to be registered is a “unique name” identifying a particular network resource, but the name resolution cache indicates that the name is a group name.

The prior known (e.g., NetBT) naming proxy operates in association with a single network interface. All requests for name resolution are received, resolved and responded to with reference to a same network interface. Such a naming proxy supplies useful information about the addresses of resources connected to a single local area network. The known naming proxy, when executed within a gateway/RAS server machine, is of limited value to a remotely connected machine. In particular a naming query request submitted by the remotely connected machine to the gateway/RAS server results in a naming request forwarded back to the remotely connected machine. However, in some instances the remotely connected machine may need the address of a named resource on a local area network to which the RAS server is connected. Due to the above-described limitations of the known naming proxy, a dialup client connected via a first interface could not specify a name for a resource connected to a sub-network via a second network interface of the RAS server.

### SUMMARY OF THE INVENTION

The present invention comprises a new method and multi-interface proxy for facilitating name-to-address mapping services throughout a network comprising subnets, and wherein the subnets are connected via at least two interfaces on a RAS server and/or gateway machine. By embodying a more universal name registration and resolution scheme (on multiple connected interfaces), naming services are extended to all subnets connected via the at least two interfaces thereby enabling a device on a first subnet to obtain an address corresponding to a named resource residing on a second subnet. The present inventive naming proxy is not confined to RAS servers and gateways. For example the naming proxy functionality described herein can be incorporated into routers connecting multiple subnets.

The present invention comprises a method for carrying out naming services by a multiple interface naming proxy operating upon a machine connected to multiple subnet links via distinct network interfaces. The multiple interface naming proxy receives a network resource name resolution query on a first one of the distinct network interfaces and forwards a naming request via a second one of the distinct network interfaces to facilitate rendering a corresponding network address of a resource residing on a subnet coupled to the machine. More particularly the method comprises the multiple interface naming proxy first receiving, by via the first network interface, the network resource name resolution query. Such a query is received, for example, by a RAS server from a RAS client. Next, a name resolution request corresponding to the network resource name resolution query is transmitted, via at least the second network interface. The transmission of such request is intended to be received and responded to by a name server or other device connected to a subnet connected to the machine via a link connected to the second network interface. The name server or other device transmits a name response including a network address corresponding to the name. The machine receives, via the second network interface, the name response including a network address for the resource residing on the subnet coupled to the machine via the second network interface.

In addition to the above-described steps, the present invention contemplates various actions subsequent to the machine receiving the name response including the resource address. The machine may forward the initially received request to the originator of the name query. In another embodiment the machine forwards datagrams (or any other suitable message unit) to the resource on behalf of the originator of the name query. Furthermore, an embodiment of the invention includes a cache memory maintained by the naming proxy for storing resolved names and their corresponding addresses to facilitate prompt responses to subsequent naming requests identifying the resource.

### BRIEF DESCRIPTION OF THE DRAWINGS

The appended claims set forth the features of the present invention with particularity. The invention, together with its objects and advantages, may be best understood from the following detailed description taken in conjunction with the accompanying drawings of which:

FIG. 1 is a schematic drawing illustratively depicting an exemplary computing environment for a machine carrying out an embodiment of the present invention;

FIG. 2 is a schematic diagram depicting components of an exemplary network including a local area network, a connected RAS server including an embedded multi-interface proxy, and a remotely connected RAS client;

FIG. 3 is a schematic diagram depicting components of an exemplary alternative network including a first and second local area network, a connected RAS server/gateway including an embedded multi-interface proxy, and a remotely connected RAS client;

FIG. 4 depicts a set of fields included within a naming cache table;

FIG. 5 depicts a set of fields included within a name/address entry within a bucket of a naming cache table; and

FIG. 6 is a flowchart summarizing the steps performed by the naming proxy in response to receiving naming requests over multiple interfaces.

### DETAILED DESCRIPTION OF ILLUSTRATIVE EMBODIMENTS

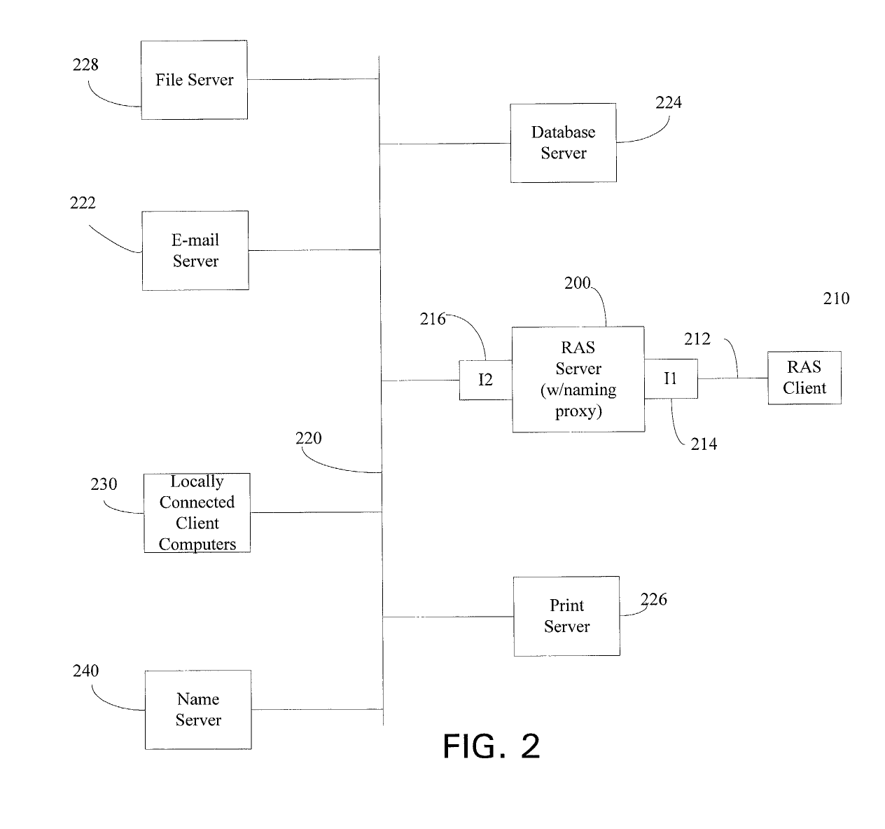

The need for a solution to the present problem of resolving names over network topologies comprising multiple-connected subnets is addressed by the enhanced naming proxy disclosed herein. In an embodiment of the present invention, the expanded naming capabilities are carried out through enhancements to the known MICROSOFT Wins proxy. In contrast to the prior known naming proxy, the disclosed naming proxy maintains name-to-address caches over multiple differing network interfaces. In an embodiment of the invention, a RAS server incorporating such a naming proxy utilizes the above mentioned multiple-interface name registration/resolution capability of the enhanced naming proxy to respond to name resolution requests received via a dial-up link interface for named resources on a subnet connected to the RAS server via a separate and distinct interface (see, FIG. 2). Therefore, the dial-up client need not know a network address to access a resource on the connected subnet.

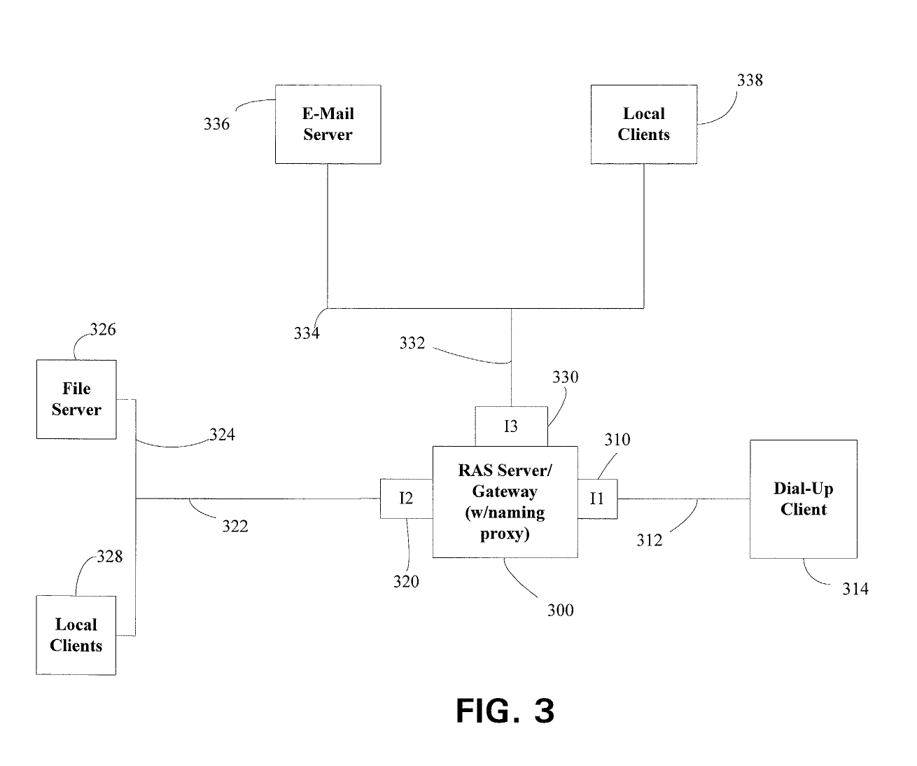

In an alternative embodiment (see, FIG. 3), the functionality of the naming proxy within the RAS server is extended to handle name resolution with regard to multiple subnets connected to the RAS server via distinct physical interfaces. In yet another embodiment of the invention the name resolution capability over multiple interfaces is incorporated into a naming proxy operating within a gateway/router that joins multiple subnets. The gateway/router receives, via a first subnet interface, a resource name from a computer connected to a first subnet. The naming proxy resolves the name and renders a corresponding network address for a resource residing on a second subnet coupled to the gateway/router via a second subnet interface.

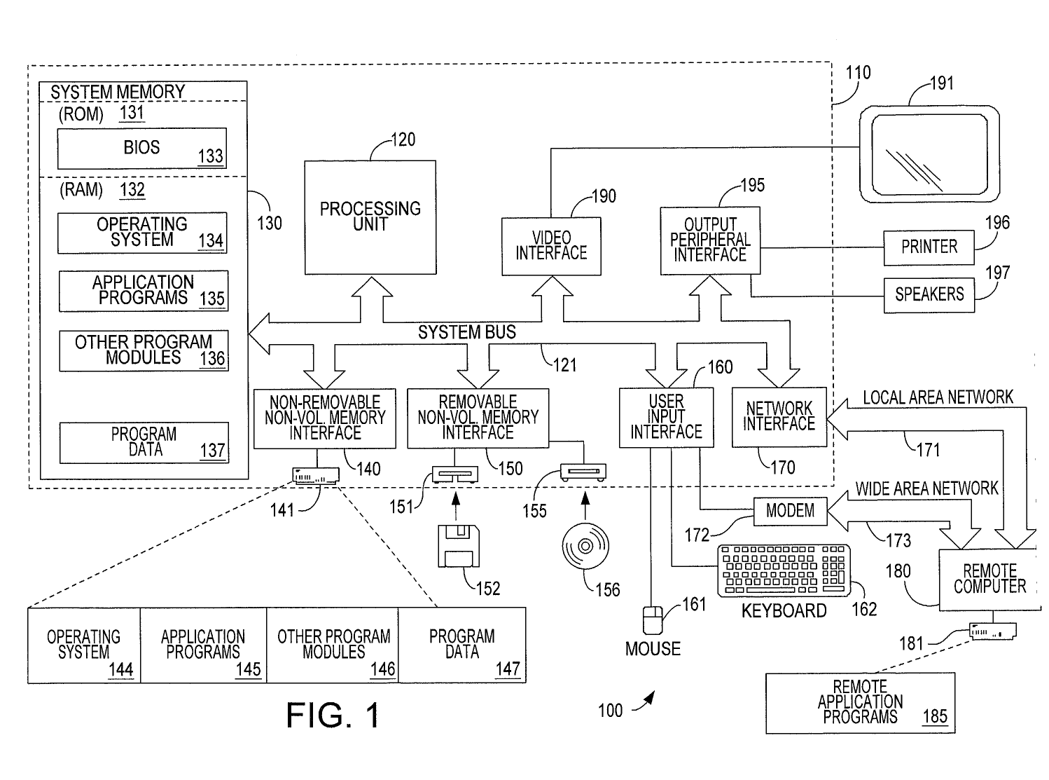

In an embodiment of the present invention, the disclosed naming proxy comprises system software executed within a computer operating environment such as the one depicted in FIG. 1, and in particular one that supports at least two communication interfaces (e.g., including one or more of the interfaces 160 (modem) and/or 170 (LAN)). A first communication interface for receiving a naming query and at least a second communication interface coupled to a subnet containing a resource corresponding to the naming query. FIG. 1 illustratively depicts an example of a suitable operating environment 100 within which the invention is implemented.

The operating environment 100 is only one example of a suitable operating environment and is not intended to suggest any limitation as to the scope of use or functionality of the invention. Other well known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like, either alone or in combination.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With continued reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Having described an exemplary computing environment for executing a naming proxy embodying the present invention, attention is directed to FIG. 2 that depicts an exemplary network topology within which the present invention is practiced. In particular, the exemplary network environment includes a RAS server 200 that provides access by dial-up clients, such as remote client 210 (connected via link 212), to a set of resources coupled to a shared communication link of a subnet 220. The link 212 is for example, a voice quality dial-in modem link. However, in exemplary alternative embodiments the link 212 is an integrated services data network (ISDN), a virtual private network (VPN) or a coaxial cable link. The RAS server 200 includes a first communication interface 214 including both hardware and software facilitating remote communications between the RAS server 200 and the remote client 210. The RAS server 200 includes a second communication interface 216 facilitating communications between the RAS server 200 and the set of resources coupled to the subnet 220. The RAS server 200 also includes the aforementioned enhanced naming proxy facilitating naming services for the connected RAS client 210 with regard to the resources on the attached subnets such as the subnet 220.

The resources connected to the subnet 220 include, by way of example, an email server 222, a database server 224, a print server 226, and a file server 228. The connected server resources are merely exemplary as those skilled in the art will readily appreciate that the type of connected resources varies in alternative embodiments of the present invention. The exemplary network environment also includes a plurality of locally connected client computers 230.

Each of the resources on the subnet 220 includes an assigned name and network address. The network address is, by way of example, designated according to the Internet Protocol (IP). However, other network addressing schemes will be known to be usable in association with the present invention. The network address is utilized to address packets on the shared link 230 to a particular one of the identified resources. Response messages from the resources also include the address of the sending resource. In this way there is a reasonable level of assurance that transmitted packets will be received by their intended recipients.

The names-to-address mapping of the resources connected to the subnet 220 is maintained in a number of different ways in accordance with alternative embodiments of the invention. In the exemplary embodiment, a name server 240 (e.g., WINS) maintains a name and corresponding network address for each registered resource on the subnet 220. The name server 240 responds to name queries from the enhanced naming proxy component within the RAS server 200. In the case of a subnet including a name server such as the one depicted in FIG. 2, names that are not present in the name cache of the naming proxy of the RAS server 200 are resolved by directing queries received by the RAS server 200 to the name server 240. Alternatively, the names and addresses are maintained via a distributed naming process wherein individual resources designate and maintain their own name and network address and the addresses are discovered through solicited/unsolicited broadcasts.

The enhanced naming proxy within the RAS server 200, like its predecessor, forwards requests on an interface from which the naming requests are received. However, in contrast to its known predecessor, the enhanced naming proxy is capable of forwarding a request received on a first interface (e.g., a dial-up modem) to all interfaces currently operating on the RAS server 200. Because this enhanced behavior is not desirable in all instances, two variables are included. A first variable enables the multiple interface naming request forwarding feature of the present invention. When set, received naming requests are forwarded on all connected interfaces. For the RAS server 200, this means that name resolution is facilitated from RAS to LAN, LAN to LAN (see FIG. 3), and LAN to RAS. A second variable is a flag supplied in the enhanced naming proxy for each interface that will enable forwarding to be suspended on a particular link for which such action is for example undesirable, unneeded, or not useful. For example, when the RAS server 200 is installed, the flag is set to disable forwarding requests on the dial-up interface. This setting prevents name resolution requests from passing from the subnet 220 to the RAS client 210. Thus, traffic across the relatively slow link 212 is minimized.

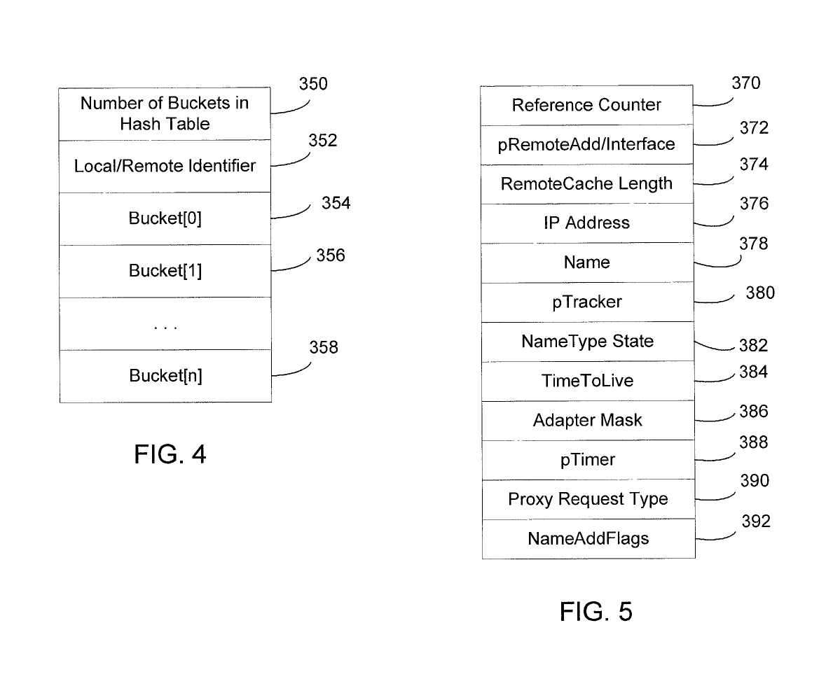

Another modification to the structure of the naming proxy operating within the RAS server 200 is the creation of a table (referred to herein as a “naming cache”) that stores the names and corresponding addresses for resources on subnets connected to all network communication interfaces on the RAS server 200. An exemplary format/structure for the multi-interface naming cache maintained by the naming proxy is set forth in FIGS. 4 and 5 described herein below.

The present invention is not confined to a RAS server connected to a single subnet. As depicted in FIG. 3, the present multi-interface naming proxy functionality is also incorporated into a RAS server/gateway 300 including a first interface 310 coupled via link 312 to a dial-up client 314. The RAS server/gateway 300 also includes a second interface 320 coupled via link 322 to a subnet 324 including a file server 326 and local clients 328. A third interface 330 is coupled via link 332 to a subnet 334 including an email server 336 and local clients 338. Subnets 324 and 334 also include name servers (not shown) that respond to name query requests forwarded by the a naming proxy within the RAS server/gateway 300. The naming proxy within the RAS server/gateway 300 includes a naming cache including the name-to-address mappings of previously resolved resource names on at least subnets 324 and 334. The naming cache is divided into a “local cache” and a “remote cache.” The local cache typically stores name-to-address mappings for names registered or owned by a local client. The remote cache typically stores name-to-address mappings for names owned by remote hosts. Dividing the naming cache into local/remote entries enables the naming proxy to apply differing rules for updating and flushing stored contents based upon the relative stability of the mappings for the resources stored within each cache.

It is noted that the naming cache tables and set of fields within a table entry described herein below with reference to FIGS. 4 and 5 are exemplary, and those skilled in the art will appreciate that the set of fields are modified in accordance with alternative embodiments of the invention. Turning to FIG. 4, an exemplary hash table structure is illustratively depicted. As previously mentioned, the exemplary naming proxy maintains at least two such structures, one being a local cache, the other being a remote cache. The hash table structure includes a buckets number field 350 identifying the total number of name/address entries in the hash table. A local/remote field 352 stores a value identifying whether a particular hash table represents a local or remote set of name/address entries. Thereafter, bucket entries 354, 356 and 358 store a set of name/address mapping entries. An exemplary name/address mapping entry structure is described herein below with reference to FIG. 5.

The number of buckets, “n”, is for example 16. However, in an alternative embodiment of the invention where the number of name/address entries in a particular table is potentially considerably larger, each table comprises 255 buckets (to potentially reduce the number of name/address entries associated with each bucket). The number of buckets is a design consideration subject to the needs and constraints of particular systems within which the present invention is incorporated. Once the number of buckets is selected, an index function computes a bucket, of the set of n buckets, into which a particular resolved name/address pair is placed. The index function, for example, bases bucket selection upon the name and the number of buckets within the table.

Turning to FIG. 5, a set of fields included within a name/address naming cache table entry are illustratively depicted. A reference counter field 370 stores a value representing the distinct threads that are potentially going to access the particular name/address entry in the table. A pRemoteAdd/Interface 372 stores a pointer to an array structure containing remote addresses on a per interface basis. The number of array entries corresponds to the number of adapters configured on the local machine. Each entry represents addresses associated with a particular adapter. The array entries themselves are structures including: (1) a best unique IP address to be used for the particular adapter, and (2) a pointer to a structure containing all other IP addresses to which the name resolves to on the particular adapter. Thus, for a host machine having three distinct network adapters, the array structure has three array entries of the type just described.

A RemoteCache Length field 374 stores a value for tracking the size of the array structure associated with the pRemoteAdd/Interface field 372 to prevent overflow. An IP address field 376 stores a default address for the name (in cases where the user does not care about addresses for specific adapters). A Name field 378 stores a NetBios name (16 bytes). A pTracker field 380 stores an address pointing to a structure for tracking name service requests (e.g., name query, connects, etc.). A NameType State field 382 stores a value describing whether the name is a unique name (e.g., a resource) or a group name plus state of name. A TimeToLive field 384 stores a value corresponding to when the name entry has expired and should be removed from the naming cache. An adapter mask field 386 stores a bit mask for a set of adapters upon which the name is active. A pTimer field 388 stores an address associated with a timer for tracking timer-related tasks such as, for example, retrying name query/registration/release requests. Alternatively, the timer facilitates deleting entries with expired time-to-live values. A proxy request type field 390 stores a value indicating the type of request by proxy services (e.g. query or registration) that created the name/address entry. A NameAddFlags field 392 stores values representing how the name was added to the cache. Examples include adding the name in response to a query to a WINS server or a DNS server, via a broadcast, by reading an LmHosts file (that contains a static list of Name-to-address mappings), or whether it was resolved as a result of an adapter status request (a reverse lookup mechanism that returns a machine name given to an IP address).

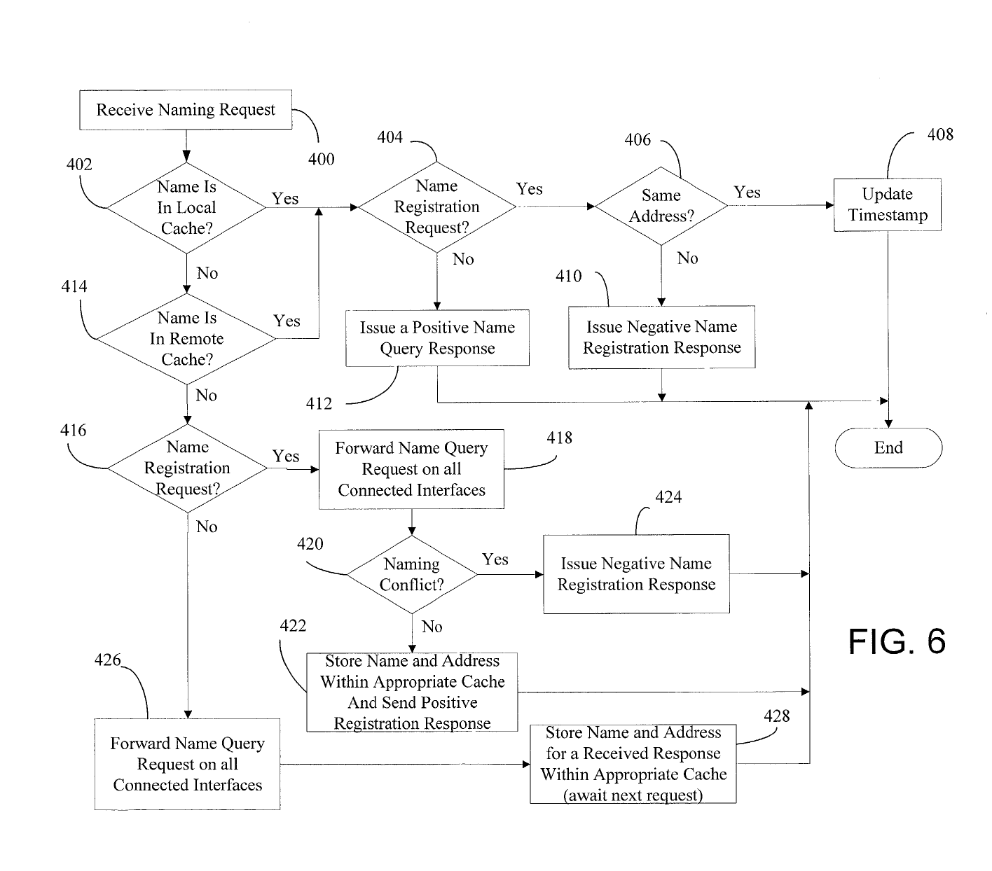

Having described exemplary network configurations including naming proxies embodying the present invention as well as the content/structure of an exemplary naming cache, attention is now directed to FIG. 6 that depicts a flowchart summarizing the steps performed by a RAS server having an embedded naming proxy in response to receiving a naming request (either name registration or name query). For purposes of illustration, reference will be made to the network depicted in FIG. 3. However, the steps are applicable to any other naming proxy operating upon a networked computer including at least two distinct network communication interfaces. For purposes of illustration, it will be assumed that the RAS server/gateway 300 receives the request from the dial-up client. However, it is noted that in embodiments of the present invention the RAS server/gateway listens and performs naming proxy services for devices connected to subnets accessed via the RAS server/gateway interfaces.

During step 400 the RAS server/gateway 300 receives a naming request and passes the request to the embedded naming proxy, including a specified resource name and request type code, from the dial-up client 314 via interface 310. As mentioned herein above, the exemplary embodiment of a naming proxy includes a local and remote cache. Thus, during step 402 the naming proxy determines whether the local cache contains a mapping entry corresponding to the specified resource name. If an entry corresponding to the specified resource name is present in the local cache, then control passes to step 404.

During step 404 if the request type code indicates that the request is a name registration request, then control passes to step 406. If the address in the cache entry corresponding to the received name is the same, then the timestamp field (TimeToLive field 384) for the cache entry is updated (or reset) during step 408 and control passes to the End. However, if the address differs, then control passes to step 410. Cases where a name is the same, but the address differs, typically indicate that two distinct resources are attempting to register under a same name with a naming service. Therefore, at step 410 the naming proxy issues a negative name registration response to the sender of the name registration request via the interface upon which the name registration request was received (in this case interface 310) by the RAS server/gateway 300. Control then passes to the End.

If at step 404, the naming request was not a registration request, then the request was a naming query and control passes to step 412. For example, the naming query received via interface 310 identifies the email server 336 on subnet 334 connected to the RAS server/gateway 300 via interface 330. During step 412 the naming proxy of the RAS server/gateway 300 issues a positive name query response to the sender of the name query request via the interface upon which the name query request was received (in this case interface 310). The positive name query response includes the address (e.g., Internet address of the email server 336) corresponding to the resource name received by the naming proxy during step 400. Control then passes to the End.

Having described the flow of potential operations when a name is present in the local cache, the description of FIG. 6 returns to step 402 and addresses the operation flow when the resource name within a received naming request is not present in the local cache. In such instances, control passes to step 414. during step 414 the naming proxy determines whether the remote cache contains a mapping entry corresponding to the specified resource name. If an entry corresponding to the specified resource name is present in the remote cache, then control passes to step 404. Steps 404-412 are described herein above. These steps are performed with reference to the contents of the remote cache.

If the received name is not present in the remote cache, then control passes to step 416. During step 416 if the request type code indicates that the request is a name registration request, then control passes to step 418. During step 418 the naming proxy issues name queries to all enabled connected subnets (via the interfaces). As noted previously above, certain interfaces can be disabled with regard to forwarding naming requests. For example, the dial-up interface 310 is a likely candidate for not forwarding a name query request since it is a relatively slow link with a single, temporarily connected computer. After forwarding the name query request onto the multiple connected interfaces (e.g., interfaces 320 and 330) control passes to step 420. During step 420 the naming proxy determines whether a name conflict exists with regard to the name transmitted during step 418. If no responses (from a machine other than the one seeking to register a name) are received by the naming proxy for a period of time after the initial query is transmitted, then no naming conflicts exist with regard to the name. Control passes from step 420 to step 422 wherein the naming proxy creates and stores, within one of its naming caches, a name entry (see e.g., FIG. 5) corresponding to the registration request received during step 416. The naming proxy also issues a positive name registration response to the requesting machine. The name and address information will reside within the cache for a period of time (e.g., 10 minutes), and will be flushed unless a subsequent received message causes the timestamp (TimeToLive) for the entry to be updated in the cache. If however during step 420 a naming conflict is detected (e.g., another machine having the name has responded positively to the name query), then control passes to step 424. During step 424 the naming proxy issues a negative name registration response to the requesting machine, and control passes to the End.

If the request was not a name registration request, then control passes from step 416 to step 426. In this case a name query has been received for which a corresponding entry is not present in the naming proxy's caches. Therefore, during step 426 the naming proxy issues name resolution queries to all enabled connected subnets (via the interfaces). After forwarding the name request onto the multiple connected interfaces (e.g., interfaces 320 and 330), during step 428, in response to receiving a response to the naming request via one of the network interfaces, the naming proxy creates a name entry within the appropriate naming cache. It is noted that rather than sending a received response back to a requesting client, the naming proxy waits for a next request before providing the resolved name information (e.g., an IP address). Thus, after creating a corresponding naming cache entry, control passes to the End.

It is noted that forwarding a response to the requesting client after step 428 is not necessarily needed because the naming proxy issues a name query on behalf of, and identifies, a requesting client. Thus, naming query responses are issued to the requesting client. The embedded proxy waits/listens for, and extracts, such naming query responses from appropriate sources of name-to-address information. The sources are the named resources themselves, or alternatively the sources are the name servers (e.g., WINS server).

In the exemplary embodiment of the invention, if a name query response is received by the naming proxy in response to the name query forwarded during step 426, then the name and address are merely stored by the naming proxy (during step 428) in the appropriate cache. If the requesting client was unable to recognize the response stored during step 428, then a second name query must subsequently be received by the naming proxy before the address for the named resource is returned (during step 412) to the requesting client.

However, in an alternative embodiment of the invention, the proxy immediately forwards a name-to-address mapping registration, received as a response to a name resolution query issued during step 426, to the requesting client. Alternatively, responses to the request, issued in the name of the dial-up client 314, are addressed to the dial-up client and are forwarded through the RAS server/gateway 300 without passing through the naming proxy operating thereon. In yet another embodiment of the invention, the address is utilized by the RAS server/gateway 300 to establish a connection between the named resource and the RAS server/gateway 300 on behalf of the dial-up client 314.

Illustrative embodiments of the present invention and certain variations thereof have been provided in the Figures and accompanying written description. The present invention is not intended to be limited to the disclosed embodiments. Rather the present invention is intended to cover the disclosed embodiments as well as others falling within the scope and spirit of the invention to the fullest extent permitted in view of this disclosure and the inventions defined by the claims appended herein below. Thus, for example, while the naming proxy has been incorporated into a RAS server machine in the disclosed embodiments, the naming proxy of the present invention is implemented within virtually any machine providing naming services to clients connected together via multiple sub-networks.

What is claimed is:

1. A method for handling, by a multiple interface naming proxy operating upon a machine connected to multiple subnet links via distinct network interfaces, a network resource name service request received on a first one of the network interfaces to facilitate rendering a corresponding network address of a resource residing on a subnet coupled to the machine via a second one of the distinct network interfaces, the method comprising the steps of:
first receiving, by the multiple interface naming proxy via the first network interface, the network resource name service request;
first transmitting, via at least the second network interface, a name query request corresponding to the network resource name service request; and
second receiving in response to the first transmitting step, by the machine via the second network interface, a name query response including a network address for the resource residing on the subnet coupled to the machine via the second network interface.

2. The method of claim 1 wherein the multiple interface naming proxy maintains a cache of name-to-address entries, and further comprising the step of:
determining, by the multiple interface naming proxy in response to the first receiving step, that the cache does not contain an entry corresponding to a name identified in the name service request.

3. The method of claim 1 wherein the machine executes a remote access server (RAS) server.

4. The method of claim 3 wherein the first network interface is a RAS interface.

5. The method of claim 4 wherein the second network interface is linked to a local area network (LAN).

6. The method of claim 3 further comprising the steps of:
accessing, by the RAS server, the network address received by the machine during the second receiving step; and
establishing, by the RAS server on behalf of the RAS client, a connection between the RAS server and the resource residing on the subnet coupled to the machine via the second network interface.

7. The method of claim 3 further comprising the step of:
transmitting the network address via the first network interface to a RAS client.

8. The method of claim 1 wherein the network address is an internet protocol (IP) address.

9. The method of claim 1 wherein the first network interface and second network interface are linked to distinct local area networks (LANs).

10. A computer-readable medium having computer-executable instructions for facilitating handling, by a multiple interface naming proxy operating upon a machine connected to multiple subnet links via distinct network interfaces, a network resource name service request received on a first one of the network interfaces to facilitate rendering a corresponding network address of a resource residing on a subnet coupled to the machine via a second one of the distinct network interfaces, the computer-readable medium having computer-executable instructions facilitating performing the steps of:
first receiving, by the multiple interface naming proxy via the first network interface, the network resource name service request;
first transmitting, via at least the second network interface, a name query request corresponding to the network resource name service request; and
second receiving in response to the first transmitting step, by the machine via the second network interface, a name query response including a network address for the resource residing on the subnet coupled to the machine via the second network interface.

11. The computer-readable medium of claim 10 wherein the multiple interface naming proxy maintains a cache of name-to-address entries, and further comprising computer-readable instructions facilitating performing the step of:
determining, by the multiple interface naming proxy in response to the first receiving step, that the cache does not contain an entry corresponding to a name identified in the name service request.

12. The computer-readable medium of claim 10 wherein the first network interface is a RAS interface.

13. The computer-readable medium of claim 12 wherein the second network interface is linked to a local area network (LAN).

14. The computer-readable medium of claim 12 further comprising computer-executable instructions for performing the step of:
accessing, by a RAS server, the network address received by the machine during the second receiving step; and
establishing, by the RAS server on behalf of a RAS client, a connection between the RAS server and the resource residing on the subnet coupled to the machine via the second network interface.

15. The computer-readable medium of claim 12 further comprising computer executable instructions for facilitating performing the step of:
transmitting the network address via the first network interface to a RAS client.

16. The computer-readable medium of claim 10 wherein the network address is an internet protocol (IP) address.

17. The computer-readable medium of claim 10 wherein the computer-executable instructions facilitate performing the first receiving, first transmitting, second receiving steps on the machine having a first network interface and second network interface linking the machine to distinct local area networks (LANs).

18. A network server machine providing name services for responding to network resource name service requests from connected clients residing upon multiple distinct sub-nets, the network server machine comprising:
a first network adaptor coupled to a first sub-net including a naming service client;
a second network adaptor coupled to a second sub-net including a resource having a resource name and an associated network address;
a set of stored computer-executable instructions for executing a multiple interface naming proxy service facilitating performing, by the network server machine, the steps of:
first receiving, by the multiple interface naming proxy via the first network adaptor, the network resource name service request;
first transmitting, via at least the second network adaptor, a name query request corresponding to the network resource name service request; and
listening for, in response to the first transmitting step, by the machine via the second network interface, a name query response including a network address for the resource residing on the subnet coupled to the machine via the second network interface.

19. The network server machine of claim 18 wherein the multiple interface naming proxy maintains a cache of name-to-address entries, and further comprises computer-executable instructions for facilitating performing the step of:
determining, by the multiple interface naming proxy in response to the first receiving step, that the cache does not contain an entry corresponding to a name identified in the name service request.

20. The network server machine of claim 18 further comprising computer executable instructions for executing a remote access server (RAS) server.

21. The network server machine of claim 20 wherein the first network adaptor is associated with a RAS interface.

22. The network server machine of claim 21 wherein the second network adaptor is linked to a local area network (LAN).

23. The network server machine of claim 20 further comprising computer-executable instructions facilitating performing the steps of:
accessing, by the RAS server, the network address received by the machine during the second receiving step; and
establishing, by the RAS server on behalf of the RAS client, a connection between the RAS server and the resource residing on the subnet coupled to the machine via the second network interface.

24. The network server machine of claim 20 further comprising computer-executable instructions facilitating performing the step of:
transmitting the network address via the first network interface to a RAS client.

25. The network server machine of claim 18 wherein the network address is an internet protocol (IP) address.

26. The network server machine of claim 18 wherein the first network adaptor and second network adaptor are linked to distinct local area networks (LANs).
